(19) United States
(12) Patent Application Publication
(10) Pub. No.: US 2007/0280463 A1
(43) Pub. Date: Dec. 6, 2007

(54) Systems, devices, and methods for managing call requests

(76) Inventors: Farrokh Mohammadzadeh Kouchri, Boca Raton, FL (US); Bizhan Karimi-Cherkandi, Boca Raton, FL (US)

Correspondence Address: Nokia Siemens Networks;Intellectual Property Department, 170 Wood Avenue South, Iselin, NJ, 08830, US

(21) Appl. No.: 11/809,428

(22) Filed: May 31, 2007

Related U.S. Application Data
(60) Provisional application No. 60/809,748, filed on May 31, 2006.

(51) Int. Cl. H04M 3/42

(52) U.S. Cl. 379/201.01

(57) ABSTRACT

Certain exemplary embodiments can utilize a method that can include, making available, to a plurality of potential call service providers, a set of parameters associated with a received call request, and/or transferring said call request to a first potential call service provider of said plurality of potential call service providers.

### CROSS-REFERENCE TO RELATED APPLICATIONS

This application claims priority to, and incorporates by reference herein in its entirety, pending U.S. Provisional Patent Application Ser. No. 60/809,748 (Attorney Docket No. 2006P11385US), filed 31 May 2006.

### BACKGROUND

U.S. Pat. No. 7,076,037 (Gonen), which is incorporated by reference herein in its entirety, allegedly discloses that a “dynamic call routing system includes establishing a plurality of service provider accounts. The service providers submit bids for a per-call charge. A call list is created wherein the service providers are ranked from the highest bidder to the lowest bidder. A telephone call received from a potential customer is routed to the highest ranked bidder service provider on the call list. If the call is not answered or rejected, the call is rerouted to the next highest ranked service provider on the call list. The service provider's account who has received the telephone call is charged the pre-call amount bid by that service provider.” See Abstract.

United States Patent Application Publication 20030190029 (Marcus), which is incorporated by reference herein in its entirety, allegedly discloses that a “system and method that integrates a user's browsing experience with the placement of telephone calls, and to generating a revenue stream for third party service providers that direct the calls to selected telephone carriers. An autodialer runs on a computing device and routes user's calls to selected carrier's networks based on optional embodiments for carrier selection. The telephone carrier can be pre-selected by an autodialer or be user selected from an ordered list. Predetermined selections may be based on the carrier bidding the least cost, or optionally, the carrier bidding the highest reward. The rank ordering of telephone carriers can be based on a figure of merit. The telephone carriers can be rank ordered based on the carrier most often selected by the users; or optionally based on the highest reward offered to the third party service provider by the carrier.” See Abstract.

U.S. Pat. No. 6,167,124 (Johnson), which is incorporated by reference herein in its entirety, allegedly discloses that an “auction service stimulates competition between service providers to carry 800 Customers' traffic and facilitates the 800 Customer's ability to make economic choices between telecommunication carriers. In this method and system, telecommunication switches route toll-free calls (e.g., calls dialed using an NPA of 800 or 888 in the United States and, typically, paid for by the called party, the 800 Customer) in accordance with economic incentives (e.g., least cost routing) resulting from an auction process between participating telecommunication carriers (“Carriers”), administered by a bidding service provider through operation of a central processor, a computer referred to as a bidding moderator (the “Moderator”). The Moderator provides each Carrier with bid information from other Carriers for at least a portion of all point-to-point routes for which any Carrier has submitted a bid. The Carriers receiving the information will have the opportunity thereafter to submit a lower or higher bid for any point-to-point routes on which they wish, respectively, to stimulate or discourage additional traffic.“See Abstract.

### SUMMARY

Certain exemplary embodiments can utilize a method that can include, making available, to a plurality of potential call service providers, a set of parameters associated with a received call request, and/or transferring said call request to a first potential call service provider of said plurality of potential call service providers.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of an information device 2000;

FIG. 3 is a flowchart of an exemplary embodiment of a method 3000; and

FIG. 4 is a flowchart of an exemplary embodiment of a method 4000.

### DETAILED DESCRIPTION

Certain exemplary embodiments can utilize a method that can include, making available, to a plurality of potential call service providers, a set of parameters associated with a received call request, and/or transferring said call request to a first potential call service provider of said plurality of potential call service providers.

There is no known “call exchange” (like a stock exchange) for different vendors/providers of call services to compete to provide services to subscribers (i.e., callers). In fact, the subscribers tend to belong to a provider and it is in the provider's discretion to route the subscriber's call by itself or by one or more other providers (by sending the call through a trunk to another provider's switch). In this sense servicing fabrics in the current switches, inherited from TDM can be viewed as rigid. Vendors/providers typically cannot share or compete in a trading forum. A subscriber tends to be hooked to a switch, and all the subscribers calls tend to be rigidly serviced in accordance with the provider's machinery and/or dependant on the specific switch.

If a call request could be offered in an exchange where different providers could compete to process and service the call (by evaluating the call parameters, prices, etc.) and dispatch the call, then this could prove to be of great advantage for the consumer as well as providers and/or the telecommunications market in general. To enable such call trading center (CTX), the trade exchange can utilize a CTX switch that has neither routing capability nor feature-handling capability. Such CTX switch can present a pool of call requests to different providers, who can compete to service the calls associated with the call requests. In this new type of switch, different providers have their own programs running, competing against each other to rapidly evaluate and/or service call requests. This competition can be regulated inside the CTX switch so that each provider and each task has an opportunity to service a desired and/or predetermined call request.

For example, a call can be initiated by a call request that a caller's end equipment sends, directly or indirectly, to a predetermined CTX switch. In this new type of switch, different providers can have their own programs running for rapidly evaluating and/or claiming a call request, thereby competing against each other. This competition can be regulated inside the CTX switch so that each provider can have an opportunity to claim a right to service, and/or actually service, provider-desired calls.

When a call request (e.g., a message such as a SETUP message, that comes from a caller's end equipment) enters the CTX switch, which can be located at and/or be associated with a call trade center CTX that can comprise one or more CTX switches, the call request can be placed in one of several “entry levels”. Each provider can own an automated program, routine, and/or collection of machine instructions called a “task”, which can run on and/or in the CTX switch, that can evaluate each incoming call request according to provider-defined criteria. Every task (each of which can represent a provider) can have the right and/or means to review each offered call request and/or evaluate parameters associated with the call request, such as called party, calling party, requested feature, date and/or time, requested service, requested capabilities, limitations, pricing, security level, data rate, error rate, delay, jitter, noise, quality of service, etc. If the provider expresses interest in processing the particular call request, offers to process the particular call request, and/or claims the call request, the call request can be dispatched from the offered pool. Such dispatched call requests are frequently referred to herein as “Provider_Broker_Tasks”.

If a call request is not dispatched in a predetermined interval of time, then the CTX switch can change one or more parameters of the call request and/or move the call request to a higher entry level associated with a changed call request parameter(s).

Such a change might make the call attractive to additional potential call service providers. For example, if a call request is not claimed within, say, 200 milliseconds at an entry level associated with a call service charge of $0.025 per minute, the call service charge parameter can be automatically changed to, say, $0.031 per minute and/or the call request can be elevated to an entry level associated with a call service charge of $0.031 per minute. As another example, if a call request firmly seeks a call service charge of no greater than $0.04 per minute and tentatively seeks a noise level below a predetermined value, yet that call request is not claimed within, say, 450 milliseconds at an entry level associated with the requested maximum call service charge, the noise level parameter can be automatically changed to a higher value and/or the call request can be elevated to an entry level associated with the same call service charge but with a higher noise level value.

When a task dispatches the call request, the CTX switch and/or the service provider's task can:
lock the call request, such as by indicating to the operating system that the task and/or provider is interested in and/or has claimed this call request so that the operating system can take this call request out of the trading queue and/or pool and provide and/or release the call request to the task for further processing (alternatively, the task and/or operating system can set a flag on that call request indicating the locking provider is evaluating and/or processing that call request);
forward the call request to the provider's home switch, such as by copying the call request in a message block and sending the call request to the provider's home office system;
attempt to serve the call request,-potentially, but possibly in some cases not necessarily, precisely as defined by the parameters of the call request, such as by connecting the calling party to the called party, at a requested QOS level, with a requested level of security, etc.;
in case of one or more successful servicing activities, inform the CTX switch (e.g., marking a voice call request as “in progress” while in a ringing state, as “confirmed” once answered, and/or as “done” when the call is completed); and/or
when the call has been completed and/or when that provider has ceased servicing the call request, generate a Call Data Record (CDR) so that appropriate accounting information (called location, call initiation- date, call initiation time, call duration, services provided, call rate, etc.) can be created and/or the CTX switch can charge the subscriber (calling party and/or called party) for servicing the call request and/or call and/or the provider for providing an opportunity to evaluate, claim, and/or service the call request.

In the event of unsuccessful service (e.g., if a provider accepts and/or claims the call request and does not provide the requested service within a predetermined time and/or when something goes wrong with fulfillment of the call request), the CTX switch can unlock the call request, return the call request to the pool and/or queue of the CTX switch, and/or penalize the provider who unsuccessfully processed the call (such as via assessing a fixed charge, assigning a lower priority to this provider for future call requests, etc.).

A CTX can be located in a building, which can contain multiple CTX switches. These switches can be connected to existing networks in the traditional manner. The operating system in a CTX switch can define a set of Application Programming Interfaces (API's) that all Provider_Broker_Tasks can utilize to interact with and/or handle a call request in the given CTX and/or CTX switch. The API's can provide and/or be governed by any of various rules. For example, a provider can:
be granted access to install its Provider_Broker_Tasks inside the CTX switch;
actually install, modify, delete, and/or maintain its Provider_Broker_Tasks inside the CTX switch;
be provided a predetermined level of resources (e.g., processor cycles, processing time, task execution time, memory, number of call requests that a provider may dispatch from the queue in a certain time or in a certain outstanding state, trading priorities (e.g., prices, time, etc.), etc.;
utilize up to the predetermined level of resources to execute its Provider_Broker_Tasks and/or process a call request;
report, log, and/or account for successful and/or unsuccessful dispatching; and/or
be penalized (such as via a penalty charge, bid surcharge, limited call request volume, delayed task execution, lowered required execution time and/or servicing time(s), lowered level of resources, removal from an entry level, etc.) for unsuccessful dispatching, such as failing to connect the calling party to the called party's switch in a predetermined time, failing to maintain a connection until at least one of the parties terminates the call, failing to provide an agreed-upon service and/or quality of service, etc.

The CTX switch can provide one or more API's for Provider_Broker_Tasks to access and/or utilize. For example, the Provider_Broker_Tasks can be allowed to:
examine and/or view the queued call requests and/or their parameters;
lock the call requests, such as by setting a flag to indicate that the provider has taken responsibility for servicing the call request and is attempting to establish the call;
cause the CTX switch to defer and/or refuse offering this call request to other Provider_Broker_Tasks once such a flag is set;
unlock the call requests by resetting their locked flag; and/or
report completion of the call requests, such as by setting a completion flag;
etc.

These APIs can be applicable to different entry levels of call requests. Each entry level can correspond to one or more call request parameters; minimum, average, and/or maximum servicing rates chargeable by providers for servicing the call per the call request parameters; and/or levels of expected and/or actual competition to service the call. For example, entry level 0 can correspond to call requests having minimal servicing requirements (e.g., 2-way calling, intra-country calling, off-peak calling, low to moderate data rate, high to moderate error rate, high to average noise, high to average latency. etc.), the least expensive (e.g., 1 cent per minute) maximum servicing charge and/or bid, and/or the highest levels of competition. As another example, entry level 1 can correspond to call requests having somewhat more demanding servicing requirements (e.g., 3-way calling, international calling, peak-time calling, faster data rate, lower bit error rate, lower latency, etc.), a higher (e.g., 2 cents per minute) maximum servicing charge and/or bid, and/or somewhat lower degree of competition to service the call request and/or call. Even more demanding servicing requirements (e.g., on-demand video playback, video conferencing, rapid upload speed, encrypted real-time communications, SS7 or MF calls, etc.), servicing charges, and/or levels of competition can correspond to increasing higher entry levels. Call requests not dispatched and/or serviced within a predetermined time at a given level can be automatically escalated to a higher level.

The CTX switch can be owned by an entity that only provides services to other providers, rather than to traditional subscribers. The CTX switch can provide no actual servicing of calls and therefore, can be unconcerned about the subscribers' feature profiles. The feature profiles of subscribers can reside in a database residing on an external server and/or a provider's database. The CTX switch can retrieve the subscriber profile from its member who owns that specific subscriber or subscriber profile. The CTX switch can provide the subscriber feature profile and/or access to the subscriber feature profile to its member service providers (members of CTX). A CTX switch can be similar to a soft switch that can be integrated to multiple types of networks.

In certain exemplary embodiments, a method for managing calls can involve any of the following activities:
a subscriber can originate a voice call using its CPE (e.g., an SIP phone);
the call request signal can be sent to the Call Trade Exchange (CTX) via an IP network;
at the CTX, call requests can be pooled at any of various levels, the levels corresponding to call request parameters, service provider minimum, average, and/or maximum charges, and/or degrees of expected and/or actual competition;
a rule enforcer can control and/or manage one or more Providers'_Broker_Tasks;
a Call Progress Controller can move call requests packets between the levels and/or remove them after completion;
the service Providers'_Broker_Tasks can fetch, evaluate, submit a proposal to service, lock, and/or process call requests;
once a provider is awarded and/or seizes the opportunity to service a call request and/or call, the provider's switch and/or network can connect the call between the calling party and the called party (or parties) according to the corresponding call request and/or the provider's proposal and/or utilizing signaling techniques that can be proprietary to that provider; and/or
upon successful and/or unsuccessful completion of processing of a call request and/or call, the provider and/or the CTX switch can log information such as accounting, billing, and/or credit information, regarding the servicing and/or processing of the call request and/or call.

At predetermined times and/or as requested, the CTX switch can render, and/or cause an information device to render, information regarding servicing of one or more call requests.

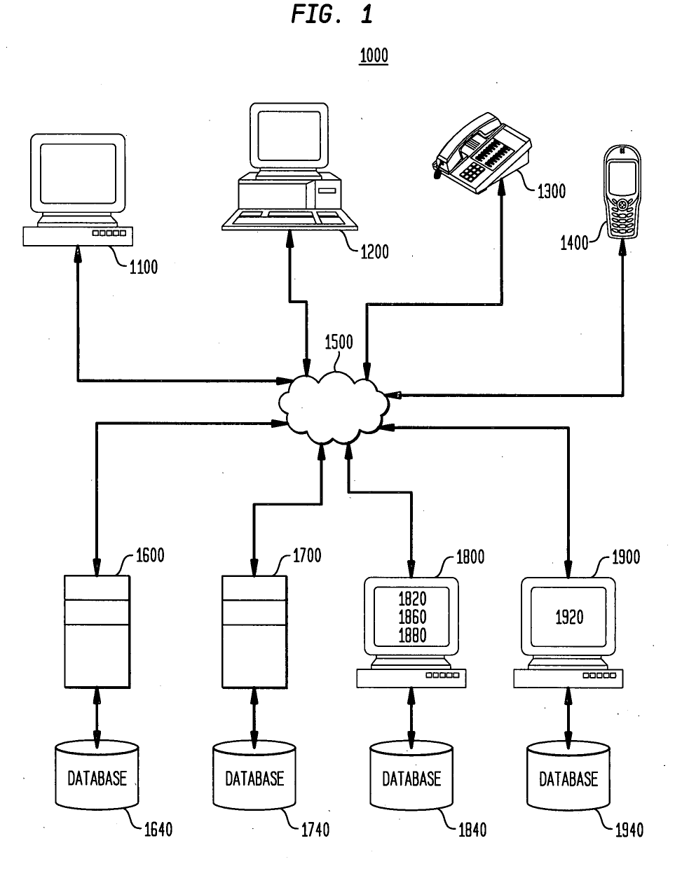

FIG. 1 is a block diagram of an exemplary embodiment of a system 1000, which can comprise any number of user communication devices, such as call generating and/or receiving devices, such as desktop computer 1100, laptop computer 1200, telephone 1300, cellular phone and/or portable communicator 1400, etc. Any of these devices can be communicatively coupled to one or more networks 1500. Also coupled to one or more networks 1500 can be one or more telecommunications service provider home switches 1600, 1700, one or more CTX switches 1800, and/or one or more servers 1900, such as one or more: subscriber profile servers, accounting servers, billing servers, and/or auxiliary service servers.

Any of home switches 1600, 1700 can be communicatively coupled to one or more databases 1640, 1740.

Any of CTX switches 1800 can comprise a parameter provision circuit 1820 adapted to automatically make available, to a plurality of potential call service providers, one or more parameters associated with a received call request. Any of CTX switches 1800 can comprise a call request transfer circuit 1860 adapted to, potentially based upon an automatic evaluation of one or more proposals to service a call associated with the received call request, the one or more proposals received, during a predetermined time period, from at least one of the plurality of potential call service providers, automatically transfer the call request to a potential call service provider from the plurality of potential call service providers, the potential call service provider potentially a first-in-time potential call service provider to claim said call request from said plurality of potential call service providers. Any of CTX switches 1800 can comprise an information rendering circuit 1880 adapted to render information regarding a servicing of said call by the first call service provider. Any of CTX switches 1800 can comprise a parameter modification circuit adapted to automatically modify at least one parameter from said set of parameters. Any of these circuits, such as circuits 1820, 1860, and/or 1880, can include and/or be communicatively coupleable to, a user interface to facilitate management thereof. To facilitate any function thereof, any of CTX switches 1800 can be communicatively coupled and/or coupleable to one or more databases 1840.

Any of servers 1900 can include a user interface 1920 to facilitate management thereof. Any of servers 1900 can be communicatively coupled to one or more databases 1940.

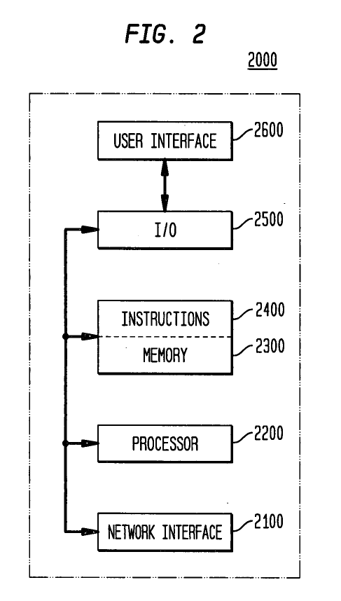

FIG. 2 is a block diagram of an exemplary embodiment of an information device 2000, which in certain operative embodiments can comprise, for example, a user communication device 1100-1400, switches 1600, 1700, 1800, and/or server(s) 1900 of FIG. 1. Information device 2000 can comprise any of numerous components, such as for example, one or more network interfaces 2100, one or more processors 2200, one or more memories 2300 containing instructions 2400, one or more input/output (I/O) devices 2500, and/or one or more user interfaces 2600 coupled to I/O device 2500, etc.

In certain exemplary embodiments, via one or more user interfaces 2600, such as a graphical user interface, a user can view a rendering of information related to researching, designing, modeling, creating, developing, building, manufacturing, operating, maintaining,-storing, marketing, selling, delivering, selecting, specifying, requesting, ordering, receiving, returning, rating, and/or recommending any of the products, services, methods, and/or information described herein.

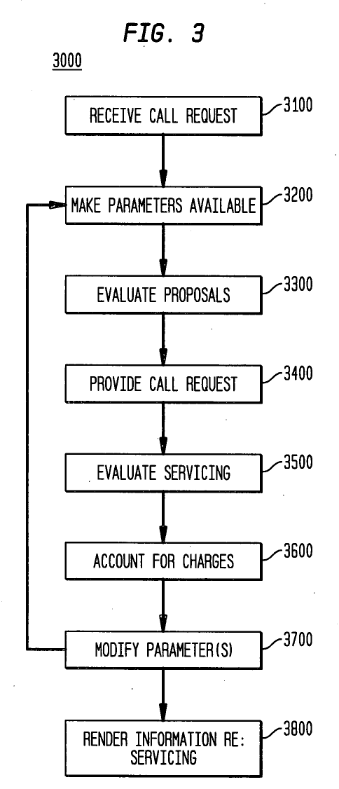

FIG. 3 is a flowchart of an exemplary embodiment of a method 3000. At activity 3100, a CTX switch can receive a call request, such as from a home switch of a service provider's subscriber and/or calling party. At activity 3200, the CTX switch can make parameters associated with the call request available and/or accessible to one or more potential service providers and/or their tasks running within the CTX switch. In certain exemplary embodiments, at activity 3300, the CTX switch can evaluate one or more proposals for servicing the call request, the proposals received from the one or more potential service providers and/or their tasks. Afterwards, at activity 3400, based on the evaluation, the CTX switch can award an opportunity to service the call request to the potential service provider associated with a “winning” proposal. Alternatively, of the service providers authorized to service that call request, such as those that are authorized to function at the same “entry level” as the call request, the first of those service providers to “seize” and/or claim a call request can thereby obtain the right to service that call request. Thus, the right to service the call request can be obtained on a “first-to-claim, first-to-serve” basis. The CTX switch or the potential service provider can “lock” the call request, thereby removing the call request from the queue and/or pool of pending call requests. The potential service provider can then attempt to service the call request by forwarding it to the potential service provider's switch for processing as if the call request had arrived at that switch essentially directly from a subscriber of that potential service provider. At activity 3500, the CTX switch can evaluate a performance of the potential service provider in servicing the call request and/or the associated call. At activity 3600, the CTX switch can account for any charges attributable to the subscriber and/or the potential service provider. At activity 3700, if the potential service provider was unsuccessful in servicing the call request and/or call, the CTX switch can modify the parameters and repeat any portion of the method, such as at activity 3200. At activity 3800, information regarding the servicing of the call request and/or call can be logged, stored, and/or rendered, such as via a user interface.

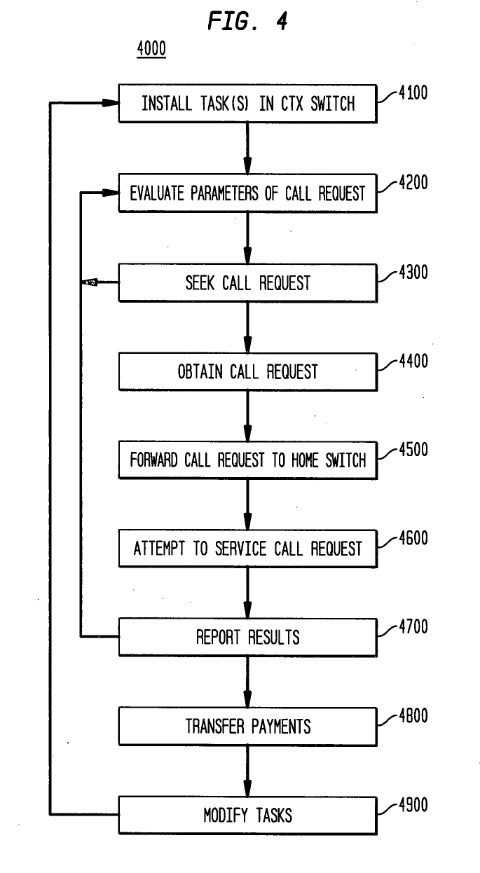

FIG. 4 is a flowchart of an exemplary embodiment of a method 4000. At activity 4100, a service provider can install one or more desired tasks, such as Provider_Broker_Tasks, in the CTX switch. At activity 4200, the service provider, via a predetermined task, can evaluate one or more parameters associated with a call request. At activity 4300, the service provider, via a predetermined task, can seek the call request. In certain exemplary embodiments, the service provider, via a predetermined task, can provide to the CTX switch one or more proposals for servicing the call request. Alternatively, based on the task's evaluation of the available call requests and/or the service provider's capabilities and/or goals, the service provider, via a predetermined task, can seize and/or claim the right to process the call request, with the first task (e.g., at a given entry level) to claim the processing right being the task to obtain that right. At activity 4400, the service provider, via a predetermined task, can obtain the call request. At activity 4500, the service provider, via a predetermined task, can forward the awarded call request to a switch at least partially owned, operated, and/or controlled by the service provider, for servicing the call request. At activity 4600, the service provider can attempt to service the call request: At activity 4700, the service provider can report a status and/or result of its attempt to service the call request. At activity 4800, the service provider can receive and/or provide payment for its role in attempting to and/or actually servicing the call request. At activity 4900, the service provider can modify one or more tasks.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved.

For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
account—(v.) to log parameters, particularly including monetary-related parameters, such as price, price per unit time, time duration, etc. associated with a particular call, call request, service provider, and/or provided service.
activity—an action, act, deed, function, step, and/or process and/or a portion thereof.
adapted to—made suitable or fit for a specific use or situation.
all—every.
and/or—either in conjunction with or in alternative to.
apparatus—an appliance or device for a particular purpose
associated with—related to.
at least—not less than.
automatic—performed via an information device in a manner essentially independent of influence and/or control by a user.
automatically—via an information device, acting and/or operating in a manner essentially independent of external human influence and/or control. For example, an automatic light switch can turn on upon “seeing” a person in its view, without the person manually operating the light switch.
based upon—determined in consideration of and/or derived from.
call—most generally any type of service, a request for which can be comprised by any type of network-transmitted electronic message. In certain exemplary embodiments and/or contexts described and/or claimed herein, the appearance of which will be readily apparent, the term “call” means a specific type of service, such as a telecommunications service, e.g., a voice communications service and/or a data communications service. For example, a “call” can be a voice call, a feature call like “call forwarding activation”, an SMS call, an email call, a print job call, an instant message call, etc.
can—is capable of, in at least some embodiments.
chosen—selected from a number of possible alternatives.
circuit—an electrically conductive pathway and/or a communications connection established across two or more switching devices comprised by a network and between corresponding end systems connected to, but not comprised by the network.
claim—(n) an assertion of a right to and/or responsibility for something; (v) to assert a right to and/or responsibility for something.
communicatively—linking in a manner that facilitates communications.
comprising—including but not limited to, what follows.
contingent—dependent for existence, occurrence, character, etc., on something not yet certain; conditional (often fol. by on or upon).
configured to—capable of performing a particular function.
couple(d)—to join, connect, and/or link two things together.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
determine—to find out or come to a decision about by investigation, reasoning, or calculation.
device—a machine, manufacture, and/or collection thereof.
during—at some time in a time interval.
evaluate—to review, examine, study, analyze, and/or consider, typically in detail.
except—excluding.
from—used to indicate a source.
further—in addition.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
interval—a time period.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can obtain and/or store data, information, and/or instructions. Examples include memories, punch cards, and/or optically-readable forms, etc.
make available—to offer, allow access to, provide, give, convey, and/or transmit etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
modify—to change, cause to change, edit, alter, replace, delete, and/or correct.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
non—not.
notify—to report, advice, and/or remind.
packet—a discrete instance of communication.
parameter—a value of a relevant variable, such as calling party, called party, requested feature and/or service, date, time, price, time to establish a connection, quality of service, noise, jitter, delay, resolution, bit rate, error rate, capability, limitation, etc.
plurality—the state of being plural and/or more than one.
potential—existing in possibility.
predetermined—determined, decided, or established in advance.
probability—a quantitative representation of a likelihood of an occurrence.
processing—(v.) to put through the steps of a predetermined procedure, such as connecting and/or sustaining a call between a calling party and a called party.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
proposal—that which is proposed, or propounded for consideration or acceptance; a scheme or design; terms or conditions proposed; an offer.
queue—(n) a group awaiting processing; (v) to place in a group awaiting processing.
receive—to gather, take, acquire, obtain, accept, get, and/or have bestowed upon.
regarding—pertaining to.
release—to let go and/or free from something that restrains, binds, fastens, and/or holds back.
render—to display, annunciate, speak, print, and/or otherwise make perceptible to a human, for example as data, commands, text, graphics, audio, video, animation, and/or hyperlinks, etc., such as via any visual, audio, and/or haptic means, such as via a display, monitor, printer, electric paper, ocular implant, cochlear implant, speaker, etc.
repeatedly—again and again; repetitively.
request—(n) that which communicates an expression of desire and/or that which is asked for.
return—to send directly or indirectly.
routing—the act of selecting a network path for a message and/or communication.
said—when used in a system or device claim, an article indicating a subsequent claim term that has been previously introduced.
selected—a chosen item.
service—(v) to produce a tangible commodity, to provide work for the benefit of others, and/or to perform work and/or duties.
service provider—an entity that has the capability to furnish, supply, give, convey, send, and/or make available a service via a network.
servicing—(n.) the act of providing a service.
set—a related plurality.
signal—information, such as machine instructions for activities, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal can be synchronous, asychronous, hard real-time, soft real-time, non-real time, continuously generated, continuously varying, analog, discretely generated, discretely varying, quantized, digital, continuously measured, and/or discretely measured, etc.
store—to place, hold, and/or retain data, typically in a memory.
substantially—to a great extent or degree.
switch—(n) a mechanical, electrical, and/or electronic device that opens and/or closes circuits, completes and/or breaks an electrical path, and/or selects paths and/or circuits and/or a device that establishes a connection between disparate transmission path segments in a network (or between networks). (v) to electrically energize or de-energize.
system—a collection of mechanisms, devices, data, and/or instructions, the collection designed to perform one or more specific functions.
telecommunications—the science and/or technology of communication at a distance by electronic transmission of waves, signals, and/or impulses.
time period—an interval of time.
transfer—(n) a transmission from one device, place, and/or state to another. (v) to convey from one device, place, and/or state to another.
unavailable—not available.
unsuccessful—not successful; failing to attain something desired or intended.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.

### Note

Still other substantially and specifically practical and useful embodiments will become-readily apparent to those skilled-in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, every portion (e.g., title, field, background, summary, abstract, drawing figure, etc.) of this application, other than the claims themselves, is to be regarded as illustrative in nature, and not as restrictive.

What is claimed is:

1. A method comprising:
within a non-routing telecommunications switch, automatically making available, to a plurality of potential call service providers, a set of parameters associated with a received call request;
automatically transferring, within a first predetermined time period, said call request from said switch to a first potential call service provider of said plurality of potential call service providers, said first potential call service provider a first-in-time potential call service provider to claim said call request from said plurality of potential call service providers;
contingent upon unsuccessful servicing of said call request by said first call service provider:
automatically modifying at least one parameter from said set of parameters;
automatically transferring, within a second predetermined time period, said call request from said switch to a second potential call service provider of said plurality of potential call service providers; and
causing a rendering of information regarding servicing of said call request.

2. The method of claim 1, further comprising receiving said call request.

3. The method of claim 1, further comprising determining said set of parameters associated with said call request.

4. The method of claim 1, further comprising automatically modifying at least one parameter from said set of parameters associated with said call request.

5. The method of claim 1, further comprising determining said plurality of potential call service providers.

6. The method of claim 1, further comprising determining said first predetermined time period.

7. The method of claim 1, further comprising, during said first predetermined time period, receiving, from said first potential call service provider, a claim to service said call request.

8. The method of claim 1, further comprising automatically releasing said call request to said first potential call service provider.

9. The method of claim 1, further comprising automatically making said call request unavailable for processing by all of said plurality of potential call service providers except said first potential call service provider.

10. The method of claim 1, further comprising automatically evaluating said first potential call service provider regarding-servicing of said call request.

11. The method of claim 1, further comprising, during a second predetermined time period, automatically evaluating said first potential call service provider regarding servicing of said call request.

12. The method of claim 1, further comprising automatically accounting for servicing of said call request.

13. The method of claim 1, further comprising automatically penalizing for said unsuccessful servicing of said calf request.

14. The method of claim 1, further comprising automatically returning said call request to a queue of received call requests.

15. The method of claim 1, further comprising automatically making said call request unavailable for processing by all of said plurality of potential call service providers except said second potential call service provider of said plurality of potential call service providers.

16. The method of claim 1, further comprising, during a predetermined interval, automatically evaluating said second call service provider regarding servicing of said call request.

17. A machine-readable medium comprising machine instructions for activities comprising:
within a non-routing telecommunications switch, automatically making available, to a plurality of potential call service providers, a set of parameters associated with a received call request;
automatically transferring, within a first predetermined time period, said call request from said switch to a first potential call service provider of said plurality of potential call service providers, said first potential call service provider a first-in-time potential call service provider to claim said call request from said plurality of potential call service providers;
contingent upon unsuccessful servicing of said call request by said first call service provider:
automatically modifying at least one parameter from said set of parameters;
automatically transferring, within a second predetermined time period, said call request from said switch to a second potential call service provider of said plurality of potential call service providers; and
causing a rendering of information regarding servicing of said call request.

18. A system comprising:
a first circuit adapted to, within a non-routing telecommunications switch, automatically make available, to a plurality of potential call service providers, a set of parameters associated with a received call request;
a second circuit adapted to, automatically transfer, within a first predetermined time period, said call request from said switch to a first potential call service provider of said plurality of potential call service providers, said first potential call service provider a first-in-time potential call service provider to claim said call request from said plurality of potential call service providers;
a third circuit adapted to, contingent upon unsuccessful servicing of said call request by said first call service provider:
automatically modify at least one parameter from said set of parameters;
automatically transfer, within a second predetermined time period, said call request from said switch to a second potential call service provider of said plurality of potential call service providers; and
a fourth circuit adapted to, cause a rendering of information regarding servicing of said call request.

19. A method comprising:
within a non-routing telecommunications switch, by a first potential call service provider of a plurality of potential call service providers, automatically evaluating a set of parameters associated with a predetermined call request;
automatically claiming, within a first predetermined time period, said call request from said non-routing switch;
automatically causing said call request to be transferred from said non-routing switch to a switch of said first potential call service provider;
automatically servicing said call request; and
automatically notifying said non-routing switch regarding said servicing of said call request.

20. A method comprising:
automatically making available, within a non-routing telecommunications switch, to a plurality of potential call service providers, one or more parameters associated with a received call request;
based upon an automatic evaluation, within said switch, of one or more proposals to service a call associated with said received call request, said one or more proposals received, during a first predetermined time period, from at least one of said plurality of potential call service providers, automatically transferring said call request from said switch to a first call service provider automatically selected from said plurality of potential call service providers; and
causing a rendering of information regarding servicing of said call request.
